(19) United States
(12) Patent Application Publication
(10) Pub. No.: US 2006/0132095 A1
(43) Pub. Date: Jun. 22, 2006

(54) Battery pack for a notebook PC

(76) Inventors: Shun-Yung Liao, Tao Yuan Shien (TW); Chun-Yi Lu, Tao-Yuan Shien (TW)

Correspondence Address: RABIN & BERDO, P.C., Suite 500, 1101 14 Street, N.W., Washington, DC, 20005, US

(21) Appl. No.: 11/125,075

(22) Filed: May 10, 2005

(30) Foreign Application Priority Data
Dec. 22, 2004 (TW) 93140104

(51) Int. Cl. H02J 7/00

(52) U.S. Cl. 320/134

(57) ABSTRACT

A battery pack for a notebook PC includes a substrate and several batteries. Several batteries are secured to a substrate and housed by a wrap material. The battery pack is connected to its corresponding connector of a notebook by a battery connector. The batteries are electrically connected to the battery connector. A fuse slot set, containing two contacts, is designed in the battery connector. When the fuse is inserted into the fuse slot set, the two contacts are electrically connected with each other so that the batteries are electrically connected to the corresponding connector of the notebook PC. When the fuse is removed from the fuse slot set, the two contacts are insulated from each other so that the batteries are electrically disconnected from the corresponding connector of the notebook PC.

### RELATED APPLICATIONS

The present application is based on, and claims priority from, Taiwan Application Serial Number 93140104, filed Dec. 22, 2004, the disclosure of which is hereby incorporated by reference herein in its entirety.

### BACKGROUND

1. Field of Invention

The present invention relates to a battery pack. More particularly, the present invention relates to a battery pack for a notebook PC.

2. Description of Related Art

A battery pack is one of the most important modules in a notebook PC. When the notebook PC is carried out of the office by a user, the battery pack may be the only power source available.

According to relevant international safety requirements, goods during shipping must be completely electrically disconnected from all power sources. A conventional way for a notebook PC being completely electrically disconnected from all power sources is to remove its battery pack. However, the removed battery pack must be separately packed from its notebook PC. More space and labor are spent in conducting this convention than if the battery were not packed separately.

For the forgoing reasons, there is a need for a manufacturing vendor to overcome the above shortcomings.

### SUMMARY

It is therefore an objective of the present invention to provide a battery pack that electrically disconnects from its notebook PC without having to be removed.

It is another objective of the present invention to provide a battery pack that electrically disconnects from its notebook PC for reducing package space and manufacturing labor.

In accordance with the foregoing and other objectives of the present invention, a battery pack for a notebook PC is provided. The battery pack includes a substrate and several batteries. Several batteries are secured to a substrate and housed by a wrap material. The battery pack is connected with its corresponding connector of a notebook by a battery connector. The batteries are electrically connected with the battery connector. A fuse slot set, containing two contacts, is designed in the battery connector. When the fuse is inserted into the fuse slot set, the two contacts are electrically connected with each other so that the batteries are electrically connected to the corresponding connector of the notebook PC. When the fuse is removed from the fuse slot set, the two contacts are insulated from each other so that the batteries are electrically disconnected from the corresponding connector of the notebook PC.

According to preferred embodiments, the battery pack of the present invention has the following advantages:

(1) When a user plans not to use a notebook PC for a long period, removing the fuse instead of the entire battery pack can achieve the same purpose as removing the entire battery pack;

(2) When the fuse malfunctions, replacing it is easy and convenient;

(3) During the shipping period, the entire battery pack can still be assembled in the notebook PC in order to save pack materials and labor costs; and

(4) Using a wrap material, instead of some housing which is manufactured by casting or molding, saves expenses of relevant costly casting or molding tools.

It is to be understood that both the foregoing general description and the following detailed description are by examples and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 illustrates a circuit diagram of a battery pack according to one preferred embodiment of this invention;

FIG. 2 illustrates a perspective view of a battery pack according to one preferred embodiment of this invention; and

FIG. 3 illustrates a perspective view of a battery pack according to another preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to overcome such shortcomings as having to remove a notebook PC's battery pack during shipping, the present invention provides a battery pack that can be electrically disconnected from its notebook PC without being removed. By designing a removable fuse of the battery pack, the notebook PC can be electrically disconnected from its battery pack during the shipping period without removing its battery pack.

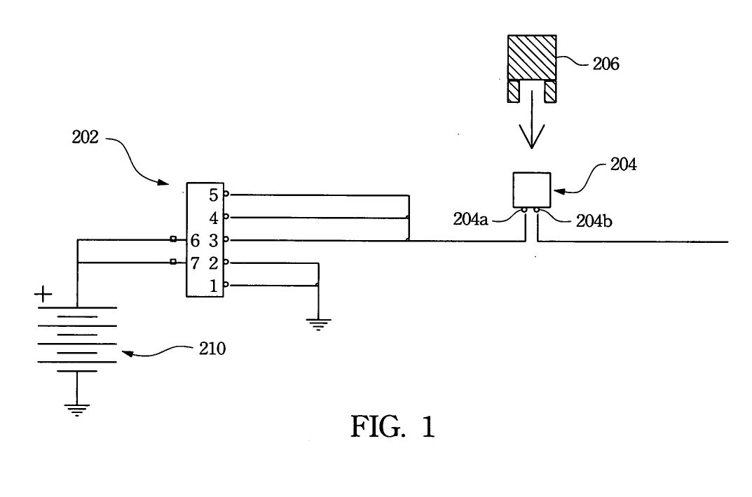

FIG. 1 illustrates a circuit diagram of a battery pack according to one preferred embodiment of this invention. The battery pack includes several batteries 210, which are connected with each other in series or in parallel. The battery pack is connected with its corresponding connector (not illustrated in FIG. 1) of a notebook by a battery connector 202. The batteries 210 are electrically connected with the battery connector 202. The circuit diagram of the battery pack includes two contacts 204a and 204b, which are electrically insulated from each other. A separate fuse 206 is used to interconnect the two contacts 204a and 204b.

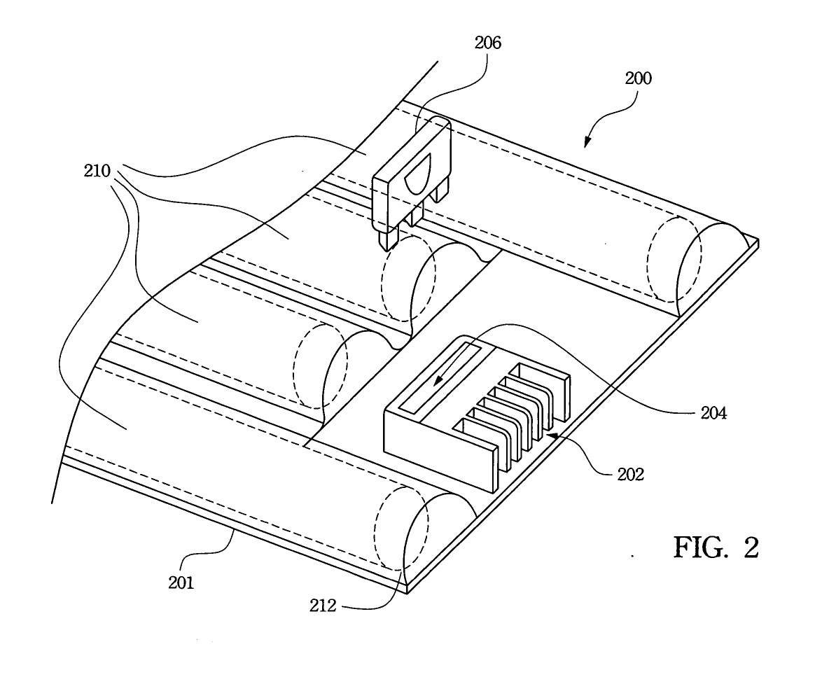

FIG. 2 illustrates a perspective view of a battery pack according to one preferred embodiment of this invention. FIG. 2 is an implementation of the circuit diagram illustrated in FIG. 1. The battery pack 200 includes several batteries 210, which are connected with each other in series or in parallel. The several batteries 210 are secured to a substrate 201 and housed by a wrap material 212. The wrap material 212 is not manufactured by casting or molding in order to save fabrication costs, such as those incurred by relevant costly casting or molding tools. The battery pack 200 is connected with its corresponding connector (not illustrated in FIG. 2) of a notebook by a battery connector 202. The batteries 210 are electrically connected with the battery connector 202. A fuse slot set 204 is designed in the battery connector 202. The fuse slot set 204 includes two contacts 204a and 204b (illustrated in FIG. 1), which are electrically insulated from each other. A fuse 206 is used to insert into the fuse slot set 204, such that the two contacts 204a and 204b are electrically interconnected with each other, making the batteries 210 electrically connected to the corresponding connector of the notebook PC. When the fuse 206 is removed from the fuse slot set 204, the two contacts 204a and 204b are insulated from each other so that the batteries 210 are electrically disconnected from the corresponding connector of the notebook PC.

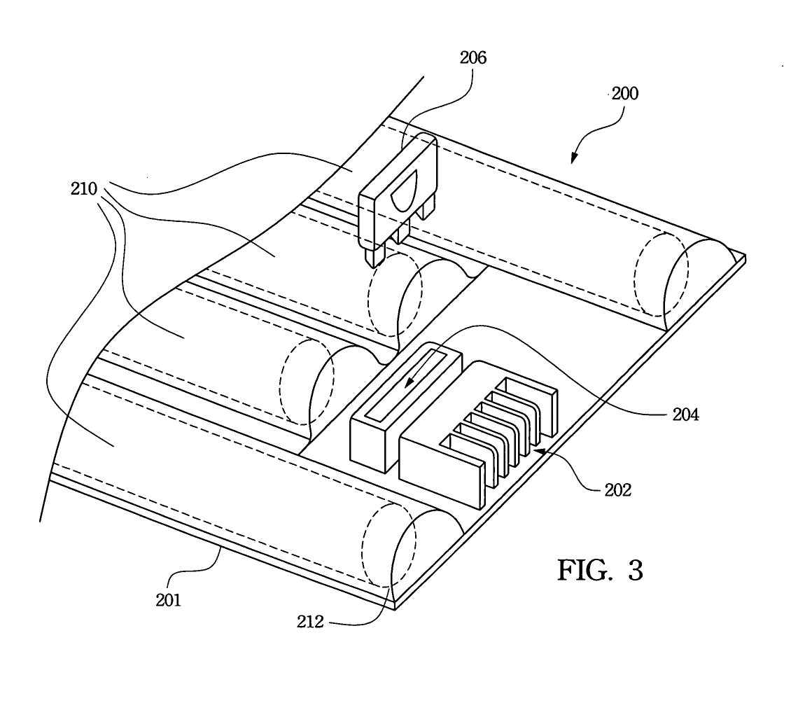

FIG. 3 illustrates a perspective view of a battery pack according to another preferred embodiment of this invention. FIG. 3 is another implementation of the circuit diagram illustrated in FIG. 1. The battery pack 200 includes several batteries 210, which are connected with each other in series or in parallel. The several batteries 210 are secured to a substrate 201 and housed by a wrap material 212. The wrap material 212 is not manufactured by casting or molding in order to save fabrication costs, such as those incurred by relevant costly casting or molding tools. The battery pack is connected with its corresponding connector (not illustrated in FIG. 3) of a notebook by a battery connector 202. The batteries 210 are electrically connected with the battery connector 202. A fuse slot set 204 here is separately designed in the battery pack. Namely, the fuse slot set 204 is electrically connected with the battery connector 202 but is an independent design from the battery connector 202. For example, the fuse slot set 204 may be positioned adjacent to the battery connector 202 or other places on the battery pack. The fuse slot set 204 includes two contacts 204a and 204b (illustrated in FIG. 1), which are electrically insulated from each other. A fuse 206 is used to insert into the fuse slot set 204, such that the two contacts 204a and 204b are electrically interconnected with each other, making the batteries 210 electrically connected to the corresponding connector of the notebook PC. When the fuse 206 is removed from the fuse slot set 204, the two contacts 204a and 204b are insulated from each other so that the batteries 210 are electrically disconnected from the corresponding connector of the notebook PC.

According to preferred embodiments, the battery pack of the present invention has the following advantages:

(1) When a user plans not to use a notebook PC for a long period, removing the fuse instead of the entire battery pack can achieve the same purpose as removing the entire battery pack;

(2) When the fuse malfunctions, replacing it is easy and convenient;

(3) During the shipping period, the entire battery pack can still be assembled in the notebook PC in order to save pack materials and labor costs; and

(4) Using a wrap material, instead of some housing which is manufactured by casting or molding, saves expenses of relevant costly casting or molding tools.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A battery pack for a notebook PC for use with a removable fuse, comprising:
a substrate;
a battery connector, mounted on said substrate, said connector being connected to a corresponding connector of the notebook PC;
a plurality of batteries, being connected with each other in series or in parallel;
a wrap material, housing said plurality of batteries on said substrate, said plurality of batteries being electrically connected to said battery connector; and
a fuse slot set, electrically connected with said battery connector, said fuse slot set including two contacts insulated from each other,
when the fuse is inserted into said fuse slot set, said two contacts being electrically connected with each other so that said plurality of batteries are electrically connected to the corresponding connector of the notebook PC,
when the fuse is removed from said fuse slot set, said two contacts being insulated from each other so that said plurality of batteries are electrically disconnected from the corresponding connector of the notebook PC.

2. The battery pack of claim 1, wherein said wrap material is not manufactured by casting or molding.

3. The battery pack of claim 1, wherein said fuse slot set is built inside said connector.

4. The battery pack of claim 1, wherein said fuse slot set and said connector are separately mounted on said substrate.

5. A battery pack for a notebook PC, comprising:
a substrate;
a battery connector, mounted on said substrate, said connector being connected to a corresponding connector of the notebook PC;
a plurality of batteries, being connected with each other in series or in parallel;
a wrap material, housing said plurality of batteries on said substrate, said plurality of batteries being electrically connected to said battery connector;
a fuse slot set, electrically connected to said battery connector, said fuse slot set including two contacts insulated from each other; and
a removable fuse, being used for inserting into said fuse slot set,
when said fuse is inserted into said fuse slot set, said two contacts being electrically connected with each other so that said plurality of batteries are electrically connected to the corresponding connector of the notebook PC,
when said fuse is removed from said fuse slot set, said two contacts being insulated from each other so that said plurality of batteries are electrically disconnected from the corresponding connector of the notebook PC.

6. The battery pack of claim 1, wherein said wrap material is not manufactured by casting or molding.
